(19) United States
(12) Patent Application Publication
(10) Pub. No.: US 2010/0070260 A1
(43) Pub. Date: Mar. 18, 2010

(54) Verification device, verifying apparatus and verification system

(75) Inventor: Souji Mori, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kswasaki (JP)

(21) Appl. No.: 12/585,388

(22) Filed: Sep. 14, 2009

(30) Foreign Application Priority Data
Sep. 17, 2008 (JP) 238291/2008

(51) Int. Cl. G06F 9/455; G06F 17/50

(52) U.S. Cl. 703/28; 716/5

(57) ABSTRACT

Provided is a verification system which improves the efficiency of operation verification in the development of digital LSIs. In the verification system, a verification device can communicate with a verifying apparatus through a bus interface. In the verification device, first and second partial circuits communicating with each other constitute a target for operation verification, i.e., a to-be-verified circuit. The verifying apparatus includes a software emulator which causes a CPU to execute, through a program, calculation corresponding to processing executed by the first partial circuit. A destination selection circuit is installed in a connection path between the first and second partial circuits, and is capable of switching a communication destination of the second partial circuit between the first partial circuit and the software emulator.

### BACKGROUND OF THE INVENTION

1. Field of the Invention

The present invention relates to operation verification of a circuit, and specifically to an operation verification technique used in the development of digital LSIs.

2. Description of the Related Art

A known approach for operation verification of a digital circuit in the development thereof is to cause a software emulator to emulate the operation of the digital circuit. Recently, with a continuous increase in size of digital LSIs, an increase in the speed of the operation verification during the development has become more and more important. Use of the following verification device for verifying a digital circuit to be developed is a frequently employed approach for achieving faster verification than a software emulator. The verification device is obtained by implementing the digital circuit in a programmable device such as a field-programmable gate array (FPGA) or a complex programmable logic device (CPLD) (Japanese Patent Application Publication No. 2006-318266 (Patent Document 1)). Such a verification device is also called a hardware emulator.

The expression “implementing a digital circuit in a programmable device” means that a programmable device is programmed to have the same circuit configuration as that of the design of a digital circuit to be developed. In the following description, a circuit obtained by implementing a digital circuit to be developed in a programmable device is called a to-be-verified circuit.

Verification approaches and methods for forming a verification device have been proposed from various points of view.

For example, a software emulator has an advantage in that a verification condition can be changed easily. Meanwhile, a hardware emulator can operate faster than a software emulator, although a digital circuit needs to be reimplemented to modify its circuit configuration. For these reasons, for the verification, the developer may want to use a software emulator in some cases and may want to use a hardware emulator in other cases. U.S. Pat. No. 6,009,256 (Patent Document 2) discloses a verification system in which a software emulator and a hardware emulator can be switched. The verification system makes it possible to switch an emulator to be used between a software emulator and a hardware emulator according to the developer's request and the like.

Japanese Patent Application Publication No. 2005-84957 (Patent Document 3) discloses a verification device in which the configuration of a to-be-verified circuit can be modified easily. The verification device includes hardware emulators which respectively correspond to multiple partial circuits constituting a digital circuit to be developed. The hardware emulators can communicate with each other through a bus. The verification device allows the verification of the entire to-be-verified circuit. Moreover, the circuit configuration of the verification device can be modified only by reprogramming a hardware emulator corresponding to a partial circuit whose configuration is desired to be modified.

Let us now consider a case where an unsatisfactory verification result is obtained in the verification of a to-be-verified circuit which includes two partial circuits communicating with each other, and where the problematic one of the partial circuits is to be specified by changing the configuration or a verification condition of one of the partial circuits and then verifying the to-be-verified circuit again. In the case of using the verification device described in Patent Document 3, the operation of the verification device needs to be stopped once to reimplement the target partial circuit.

It takes time to reimplement the target partial circuit. Furthermore, if no change is observed in a new verification result obtained by verifying the to-be-verified circuit with one of the partial circuits reimplemented, the operation of the verification device needs to be stopped again to undo the modification of the one of the partial circuits through reimplementation and to reimplement the other one of the partial circuits.

Such a method is time-consuming and exhibits poor verification efficiency.

### SUMMARY

The present invention seeks to solve one or more of the above problems, or to improve upon those problems at least in part. In one embodiment, the present invention is a verification device including a to-be-verified circuit and a destination selector. The to-be-verified circuit is a target for operation verification and includes a first partial circuit and a second partial circuit communicating with each other. The destination selector is capable of switching a communication destination of the second partial circuit between the first partial circuit and an external device.

Note that, it is also effective as another aspect of the present invention to represent the verification device of the above aspect in the form of a method, an apparatus, a system and the like. Further, a verifying apparatus and a system using the verification device of the above aspect are also effective as another aspect of the present invention.

According to the technique of the present invention, it is possible to efficiently perform operation verification in the development of digital LSIs.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a diagram showing a verification system according to a first embodiment of the present invention.

FIG. 2 is a diagram showing a verification system according to a second embodiment of the present invention.

### DESCRIPTION OF THE PREFERRED EMBODIMENTS

Embodiments of the present invention will be described with reference to the drawings.

### First Embodiment

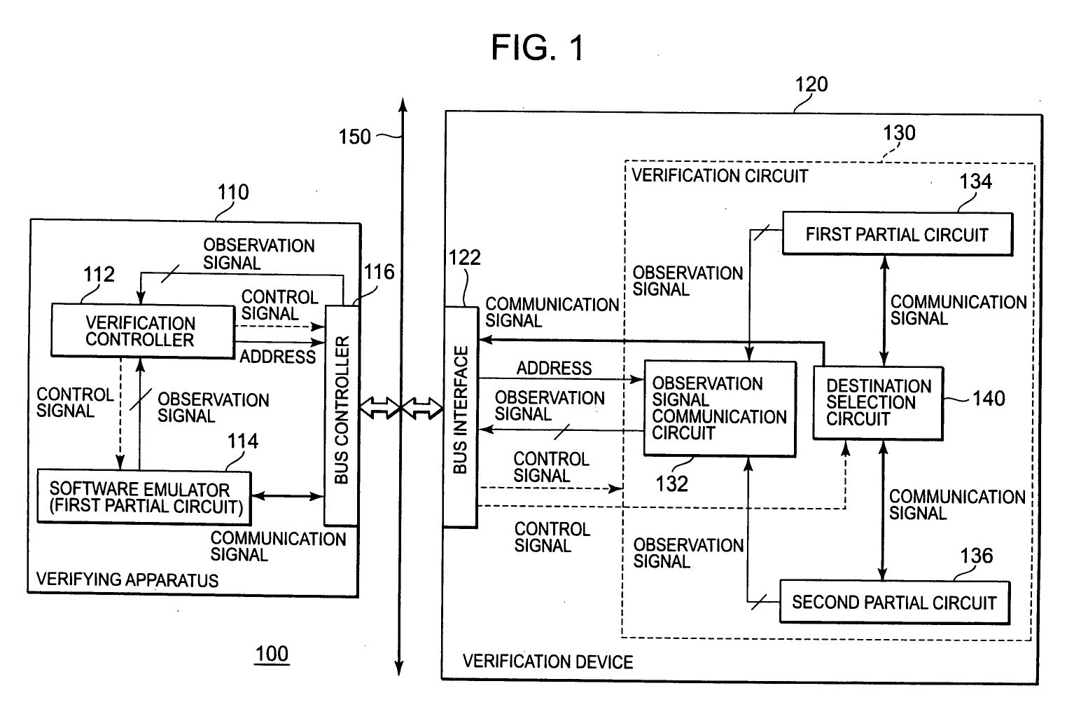

FIG. 1 shows a verification system 100 according to a first embodiment of the present invention. The verification system 100 verifies the operation of a digital LSI being developed, and includes a verifying apparatus 110 and a verification device 120. The verifying apparatus 110 and the verification device 120 are each connected to a bus 150, and perform communications via the bus 150.

The verifying apparatus 110 is a computer, and includes a verification controller 112, a software emulator 114 and a bus controller 116.

The verification controller 112 and the software emulator 114 are formed of hardware generally included in the computer, and programs installed in the computer. Here, the hardware includes a central processing unit (CPU), a memory, and the like. For example, the verification controller 112 works by causing the CPU to load a program for verification control into the memory and then to execute the program thus loaded. Meanwhile, the software emulator 114 works by causing the CPU to load a program into the memory and then to execute the program thus loaded, the program executing calculation corresponding to processing performed by a first partial circuit to be described later.

The bus 150 is a general-purpose bus. All communications between the verifying apparatus 110 and the verification device 120 are performed via the bus 150.

The bus controller 116 is connected between the bus 150 and each of the verification controller 112 and the software emulator 114. The bus controller 116 transmits, to the bus 150, signals to be outputted to the verification device 120 from the verification controller 112 and the software emulator 114. The bus controller 116 also transmits, to the verification controller 112 or the software emulator 114, a signal outputted to the verifying apparatus 110 from the verification device 120 via the bus 150.

The verification device 120 is a hardware emulator for the LSI being developed, and includes a bus interface 122 and a verification circuit 130.

The bus interface 122 relays all communications performed between the verification circuit 130 and the verifying apparatus 110. Specifically, the bus interface 122 transmits, to the bus 150, a signal to be outputted to the verifying apparatus 110 from the verification circuit 130. Meanwhile, the bus interface 122 outputs, to a specific terminal of the verification circuit 130, a signal transmitted by the verifying apparatus 110 via the bus 150.

The verification circuit 130 includes an observation signal communication circuit 132, a first partial circuit 134, a second partial circuit 136, and a destination selection circuit 140.

In this embodiment, the digital LSI being developed is, for example, formed of two circuits communicating with each other. The first and second partial circuits 134 and 136 correspond to the respective two circuits.

The destination selection circuit 140 is connected to the first and second partial circuits 134 and 136 so as to be inserted into a signal connection path between the first and second partial circuits 134 and 136. The destination selection circuit 140 switches a destination with which the second partial circuit 136 communicates, between the first partial circuit 134 and the software emulator 114 of the verifying apparatus 110. Specifically, when the destination selection circuit 140 selects the first partial circuit 134, the second partial circuit 136 communicates with the first partial circuit 134; when the destination selection circuit 140 selects the software emulator 114, the second partial circuit 136 communicates with the software emulator 114.

For facilitating the understanding of the above description, in FIG. 1, the name “first partial circuit 134” is parenthesized below the name “software emulator 114.”

The first and second partial circuits 134 and 136 constitute a to-be-verified circuit whose operation is to be verified. The to-be-verified circuit is formed by programming a programmable device, such as an FPGA, in accordance with the configuration of the digital LSI being developed. The software emulator 114 executes the same calculation as that executed by the first partial circuit 134, by executing a program on the CPU.

The observation signal communication circuit 132 has registers (not illustrated) storing therein observation signals which are outputted from the first and second partial circuits 134 and 136 and used for monitoring of the operation of these circuits. Upon receipt of an address signal from the verification controller 112, the observation signal communication circuit 132 returns, to the verification controller 112, an observation signal stored in an address indicated by the address signal.

In the verification system 100 of this embodiment, signals to be outputted from the verification controller 112 to the verification circuit 130 include control signals and the address signal described above. The control signals include a signal for controlling the overall operations of the verification circuit 130, and a signal for controlling the operation of the destination selection circuit 140. The signal for controlling the overall operations of the verification circuit 130 causes the verification circuit 130 to “start operation,” “stop operation,” or “break operation (temporary stop operation),” for example. The signal for controlling the operation of the destination selection circuit 140 gives instructions to the destination selection circuit 140 on which to select, as a communication destination of the second partial circuit 136, between the software emulator 114 and the first partial circuit 134.

The verification controller 112 outputs a control signal to the software emulator 114, and receives an observation signal from the software emulator 114.

The verification circuit 130 outputs, to the verification controller 112, an observation signal in accordance with an address received from the verification controller 112.

When the destination selection circuit 140 selects the first partial circuit 134, communication signals are transmitted and received between the first partial circuit 134 and the second partial circuit 136. Meanwhile, when the destination selection circuit 140 selects the software emulator 114, communication signals are transmitted and received between the software emulator 114 and the second partial circuit 136.

Hence, the verification system 100 of this embodiment is capable of switching the communication destination of the second partial circuit 136 between the first partial circuit 134 and the software emulator 114, through a control signal outputted to the destination selection circuit 140 by the verification controller 112. The verification system 100 thus configured can be utilized in various ways in verification. Some examples thereof will be described herein.

### First Utilization Example

Recently, various convenient tools have been used in the development of digital LSIs. Some of partial circuits constituting a digital LSI are provided by such tools and are guaranteed in operation. The operation of the partial circuits thus guaranteed does not need to be verified. Thus, the use of such tools in designing the digital LSI makes it possible to reduce a failure and the amount of work for verification.

In this regard, a utilization example of the verification system 100 will be described on the assumption that the second partial circuit 136 of the verification system 100 is guaranteed in operation.

To form the first partial circuit 134, the first partial circuit 134 is designed, and an FPGA is programmed as designed. In this case, a program to execute calculation corresponding to processing executed by the first partial circuit 134 is installed in a computer to form the software emulator 114.

At the time of verification, the verification controller 112 outputs a “start operation” control signal to the verification circuit 130 via the bus controller 116, the bus 150, and the bus interface 122 to operate the verification circuit 130.

When the verification circuit 130 starts to operate, the first and second partial circuits 134 and 136 output various observation signals to the observation signal communication circuit 132. Upon receipt of an address signal from the verification controller 112, the observation signal communication circuit 132 outputs, to the verification controller 112 via the bus interface 122, the bus 150, and the bus controller 116, an observation signal selected according to the address signal thus received.

The user may in some cases request the verification controller 112 to “temporarily stop” the verification circuit 130 through a user interface (not illustrated), in order to analyze an observation signal which is being verified. When receiving an input indicating such a request, the verification controller 112 outputs, to the verification circuit 130, a “temporary stop” control signal to break the operation of the verification circuit 130. Meanwhile, when receiving a “stop operation” request from the user, the verification controller 112 outputs, to the verification circuit 130, a “stop operation” control signal to stop the verification circuit 130.

It should be noted that the control signals indicating “break operation,” “stop operation,” and the like do not necessarily have to be outputted in accordance with an input by the developer. The verification controller 112 may be configured to output these control signals in accordance with a condition indicated by the observation signals, depending on how the verification system is designed.

The processing described thus far is the same as a verification system using an ordinary hardware emulator.

Consider a case where an observation signal received from the verification circuit 130 is not as expected. Since the second partial circuit 136 is guaranteed in operation, it is necessary to specify whether the first partial circuit 134 has a physical problem in its wiring and the like, or has a problem in design itself. Conventionally, one of conceivable methods to specify a problem is to stop the operation of the verification circuit 130, to modify the design of the first partial circuit 134, to reprogram the FPGA accordingly, and thereafter to restart the verification process described above. If the verification circuit 130 operates normally after the modification, it shows that the first partial circuit 134 has a problem in design.

However, it takes at least several hours to modify the design of the first partial circuit 134 and to reprogram the FPGA accordingly. On the other hand, if no change is observed in the condition of the verification system 100 as a result of verifying the verification system 100 again, it shows that the first partial circuit 134 has a physical problem. However, the modification having been made to the design of the first partial circuit 134 is in vain. Hence, this method is not efficient.

The use of the verification system 100 according to this embodiment makes it possible to specify a problem with the following procedure.

First, the verification controller 112 outputs, to the destination selection circuit 140, a control signal to switch the communication destination of the second partial circuit 136 from the first partial circuit 134 to the software emulator 114. Concurrently, the verification controller 112 outputs a control signal to cause the software emulator 114 to start operation.

In this case, also, the verification controller 112 may be configured to transmit control signals to the verification circuit 130 and the software emulator 114 in accordance with an instruction inputted by the user, or may be configured to output the control signals automatically in accordance with a condition indicated by the observation signals from the verification circuit 130.

The software emulator 114 is activated in response to the control signal from the verifying apparatus 110, and thereby communicates with the second partial circuit 136.

The software emulator 114 outputs an observation signal to the verification controller 112 while in operation. In order to receive an observation signal for the second partial circuit 136, the verification controller 112 outputs, as needed, the address of a register storing therein the observation signal from the second partial circuit 136, to the observation signal communication circuit 132.

When no difference is observed between the condition where the second partial circuit 136 communicates with the first partial circuit 134 and the condition where the second partial circuit 136 communicates with the software emulator 114, it shows that the first partial circuit 134 has a problem in design. Thus, redesigning and reprogramming of the first partial circuit 134 may be started from this time. By contrast, when the verification circuit 130 operates normally, it shows that the first partial circuit 134 has a physical problem. In this case, the first partial circuit 134 does not need to be redesigned.

In essence, the use of the verification system 100 as described above makes it possible to specify whether the first partial circuit 134 has a physical problem or has a problem in design, without redesigning and reprogramming the first partial circuit 134. Accordingly, verification efficiency can be improved.

Next, a description will be given of a utilization example in which neither of the first and second partial circuits 134 and 136 is guaranteed in operation.

### Second Utilization Example

The situation until an observation signal received from the verification circuit 130 is not as expected is the same as the first utilization example, and therefore a description thereof will be omitted.

When an observation signal received from the observation signal communication circuit 132 is not as expected in this utilization example, it is necessary to specify whether the first partial circuit 134 has a problem or the second partial circuit 136 has a problem. It is also necessary to specify whether the circuit has a physical problem or has a problem in design.

Conventionally, one of conceivable methods to specify a problem is to stop the operation of the verification circuit 130, to modify the design of one of the partial circuits of the to-be-verified circuit, such as the first partial circuit 134, to reprogram the FPGA accordingly, and thereafter to restart the verification process. If the verification circuit 130 operates normally after the modification, it shows that the first partial circuit 134 has a problem in design. On the other hand, if no change is observed, it is necessary to further specify whether the first partial circuit 134 has a physical problem or the second partial circuit 136 has a problem.

A conceivable method to further specify a problem is to undo the modification having been made to the design of the first partial circuit 134, to accordingly reprogram the FPGA again, to modify the design of the second partial circuit 136, and to reprogram the FPGA accordingly. This takes a huge amount of time, and thus is inefficient.

The use of the verification system 100 according to this embodiment makes it possible to specify a problem with the following procedure.

First, the verification controller 112 outputs, to the destination selection circuit 140, a control signal to switch the communication destination of the second partial circuit 136 from the first partial circuit 134 to the software emulator 114. Concurrently, the verification controller 112 outputs a control signal to cause the software emulator 114 to start operation.

The software emulator 114 is activated in response to the control signal from the verifying apparatus 110, and thereby communicates with the second partial circuit 136.

The software emulator 114 outputs an observation signal to the verification controller 112 while in operation. In order to receive an observation signal for the second partial circuit 136, the verification controller 112 outputs, as needed, the address of a register storing therein the observation signal from the second partial circuit 136, to the observation signal communication circuit 132.

When the verification circuit 130 operates normally, it shows that the first partial circuit 134 has a physical problem. In this case, the first partial circuit 134 does not need to be modified in design or reprogrammed.

When no difference is observed between the condition where the second partial circuit 136 communicates with the first partial circuit 134 and the condition where the second partial circuit 136 communicates with the software emulator 114, the software emulator 114 is modified, and the verification circuit 130 is verified again to further specify whether the first partial circuit 134 has a problem in design or the second partial circuit 136 has a problem.

When it is observed as a result of the verification that the verification circuit 130 operates normally, it shows that the first partial circuit 134 has a problem in design. Thus, reprogramming of the first partial circuit 134 may be started from this time. Note that, in this case, the modification having been made to the software emulator 114 may be applied to the first partial circuit 134. This eliminates the need to redesign the first partial circuit 134.

By contrast, when no change is observed, it shows that the second partial circuit 136 has a problem.

In essence, the use of the verification system 100 of this embodiment makes it possible to efficiently specify which partial circuit has a problem, without redesigning or reprogramming the partial circuit of the to-be-verified circuit.

In order to facilitate understanding of the technique of the present invention, in the verification system 100, the destination selection circuit 140 of the verification device 120 is designed to be able to switch the communication destination of the second partial circuit 136 between the first partial circuit 134 and the software emulator 114. However, the technique of the present invention is not limited to such a case. For example, the verifying apparatus 110 may further include a software emulator executing the same calculation as that of the second partial circuit 136 (hereinafter called a “second software emulator” for distinguishing this emulator from the software emulator 114), and the destination selection circuit 140 may be designed to be able to switch a communication destination of the first partial circuit 134 between the second partial circuit 136 and the second software emulator installed in the verifying apparatus 110. The verification system thus configured is capable of specifying a problem further efficiently in the case of the second utilization example.

Specifically, the communication destination of the second partial circuit 136 is first switched to the software emulator 114 in order to specify whether the first partial circuit 134 has a problem or the second partial circuit 136 has a problem. When the verification circuit 130 operates normally, it shows that the first partial circuit 134 has a physical problem.

On the other hand, when no change is observed, the software emulator 114 is stopped, and the communication destination of the first partial circuit 134 is switched to the second software emulator. When the verification circuit 130 operates normally, it shows that the second partial circuit 136 has a physical problem. When no change is observed, one of the software emulators, for example, the software emulator 114 is modified, the communication destination of the second partial circuit 136 is switched to the software emulator 114, and the verification circuit 130 is verified again. When the verification circuit 130 operates normally, it shows that the first partial circuit 134 has a problem in design. When no change is observed, it shows that the second partial circuit 136 has a problem in design.

### Third Utilization Example

In the development process, there is a case where, after the first and second partial circuits 134 and 136 are already formed, the developer wishes to observe how the second partial circuit 136 would operate if the configuration or verification condition of the first partial circuit 134 is changed. For example, there is a case of verifying how the second partial circuit 136 would operate when receiving a communication signal that the first partial circuit 134 cannot output under normal situation. Such verification is generally executed after the operation verification of the first and second partial circuits 134 and 136 has proceeded to a certain extent.

Such verification is heretofore executed in such a way that the verification circuit is stopped when being verified, that redesigning, reprogramming, and the like, which are time-consuming, are performed on the first partial circuit 134, and that the verification circuit is verified again from the beginning.

The use of the verification system 100 makes it possible to verify the verification circuit with the following procedure.

The software emulator 114 is configured to execute the same calculation as that executed by the first partial circuit 134, and to output, in a certain condition, a communication signal that the first partial circuit 134 cannot output under normal situation. Then, the verification controller 112 operates the software emulator 114 in synchronization with the operation of the verification circuit 130.

When an observation signal from the observation signal communication circuit 132 indicates the certain condition during the verification process, the verification controller 112 controls the destination selection circuit 140 to change the communication destination of the second partial circuit 136 to the software emulator 114. Thereafter, the software emulator 114 communicates with the second partial circuit 136, and outputs, to the second partial circuit 136, the communication signal that the first partial circuit 134 cannot output under normal situation.

In this manner, the verification system 100 can perform a desired verification without stopping the verification circuit 130 during the verification process. Thus, the verification efficiency is improved.

### Second Embodiment

In the first embodiment, the destination selection circuit 140 changes a communication destination of the second partial circuit 136 in response to a control signal from the verification controller 112. According to the technique of the present invention, the destination selection circuit 140 may change the communication destination of the second partial circuit 136 in response to at least one of communication signals between the first partial circuit 134 and the second partial circuit 136, an observation signal outputted from the first partial circuit 134 to the observation signal communication circuit 132, and an observation signal outputted from the second partial circuit 136 to the observation signal communication circuit 132.

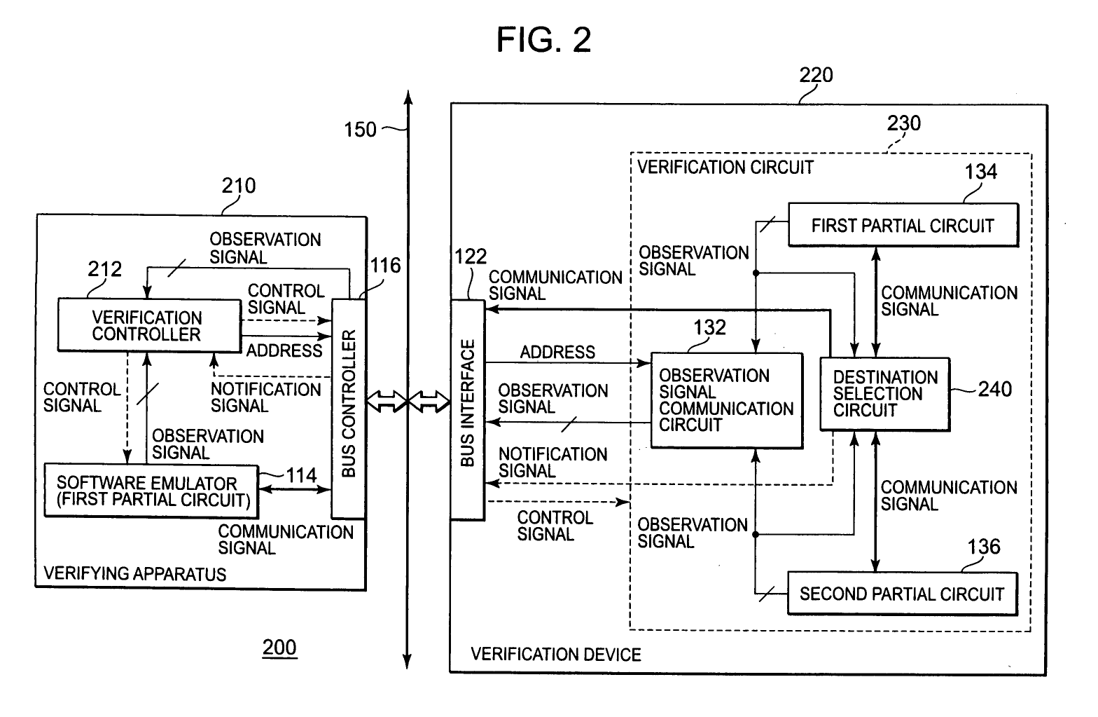

FIG. 2 shows a verification system 200 according to a second embodiment of the present invention. In FIG. 2, a part having the same configuration or function as that of the verification system 100 shown in FIG. 1 will be denoted by the same reference numeral, and a detailed description thereof will be omitted.

In a verifying apparatus 210, a verification controller 212 does not output a control signal to change the communication destination of the second partial circuit 136 unless instructed by the user's input. Moreover, when receiving, from a verification circuit 230 to be described later, a notification signal indicating that the communication destination of the second partial circuit 136 has been switched to the software emulator 114, the verification controller 212 activates the software emulator 114 and receives an observation signal from the software emulator 114. Except these two points, the verification controller 212 is the same as the verification controller 112 in the verifying apparatus 110 of the verification system 100.

In the verification circuit 230, a destination selection circuit 240 receives an observation signal outputted from the first partial circuit 134 to the observation signal communication circuit 132 and an observation signal outputted from the second partial circuit 136 to the observation signal communication circuit 132. Then, based on at least one of these observation signals and communication signals between the first partial circuit 134 and the second partial circuit 136, the destination selection circuit 240 changes the communication destination of the second partial circuit 136. For example, the communication destination of the second partial circuit 136 is changed when the communication signal from the first partial circuit 134 to the second partial circuit 136 or the communication signal from the second partial circuit 136 to the first partial circuit 134 satisfies a predetermined condition.

Upon the change of the communication destination, the destination selection circuit 240 outputs, to the verification controller 212, a notification signal notifying the verification controller 212 of the change. Except this point, the destination selection circuit 240 is the same as the destination selection circuit 140 in the verification circuit 130 of the verification system 100.

In essence, the destination selection circuit 240 of this embodiment changes the communication destination of the second partial circuit 136 in response to the control signal outputted from the verification controller 212 in accordance with an instruction inputted by the user, the observation signals or the communication signals described above. The change of the communication destination in response to the control signal from the verification controller 212 can be applied to the first and second utilization examples having been described in the first embodiment, whereas the change of the communication destination in response to the observation signals or the communication signals can be applied to the third utilization example.

Hereinabove, the present invention has been described on the basis of the embodiments. However, the above embodiments are merely an example. Thus, each of the embodiments described above may be modified, added, or reduced in various ways, or some of the embodiments may be used in combination, without deviating from the gist of the present invention. It is to be understood by those skilled in the art that the modified examples having been modified, added, reduced, or combined are also within the scope of the present invention.

For example, the verification system 100 of the first embodiment and the verification system 200 of the second embodiment may be used in combination. Specifically, for example, in response to an instruction from the user or to the observation signals, the verification controller 212 outputs, to the destination selection circuit 240, a control signal to change the communication destination of the second partial circuit 136. The destination selection circuit 240 may be configured to change the communication destination in accordance with the control signal from the verification controller 212, and to change the communication destination in accordance with the communication signals between the first partial circuit 134 and the second partial circuit 136 as well.

In order to facilitate understanding of the present invention, a description has been given by taking as an example a case where a digital LSI being developed is formed of two partial circuits. However, the technique of the present invention can be applied to the verification of a to-be-verified circuit which can be divided into any two or more partial circuits. Moreover, the above effects of the technique of the present invention can be obtained by this application.

It is apparent that present invention is not limited to the above embodiments, but may be modified and changed without departing from the scope and spirit of the invention.

What is claimed is:

1. A verification device comprising:
a to-be-verified circuit that is a target for operation verification and that includes a first partial circuit and a second partial circuit communicating with each other; and
a destination selector that is capable of switching a communication destination of the second partial circuit between the first partial circuit and an external device.

2. The verification device according to claim 1, wherein the to-be-verified circuit is formed of a programmable logic device.

3. The verification device according to claim 1, wherein the external device is a software emulator that causes a CPU to execute, through a program, calculation equivalent to processing executed by the first partial circuit.

4. The verification device according to claim 1, wherein the verification device is a hardware emulator.

5. The verification device according to claim 1, wherein the destination selector performs the switching in response to a control signal from outside.

6. The verification device according to claim 1, wherein
each of the first partial circuit and the second partial circuit not only outputs a communication signal to the other partial circuit, but also outputs an observation signal for the operation verification, and
the destination selector performs the switching on the basis of at least one of the communication signal between the first partial circuit and the second partial circuit, the observation signal outputted from the first partial circuit, and the observation signal outputted from the second partial circuit.

7. A verifying apparatus comprising:
a bus that is connected to a verification device having a to-be-verified circuit which is a target for operation verification and which includes a first partial circuit and a second partial circuit communicating with each other;
a software emulator that causes a CPU to execute, through a program, calculation equivalent to processing executed by the first partial circuit; and
a controller that is capable of performing, through the bus, control to switch a communication destination of the second partial circuit between the first partial circuit and the software emulator.

8. A verification system comprising:
a verification device that has a to-be-verified circuit which is a target for operation verification and which includes a first partial circuit and a second partial circuit communicating with each other; and
a verifying apparatus that is capable of communicating with the verification device, wherein
the verifying apparatus includes a software emulator that causes a CPU to execute, through a program, calculation equivalent to processing executed by the first partial circuit, and
the verification device includes a destination selector that is capable of switching a communication destination of the second partial circuit between the first partial circuit and the software emulator.
